(19) United States
(12) Patent Application Publication
(10) Pub. No.: US 2022/0065602 A1
(43) Pub. Date: Mar. 3, 2022

(54) FLAME ARRESTORS FOR SMOKE GRENADES

(71) Applicant: Richard Riffle, Portland, OR (US)

(72) Inventor: Richard Riffle, Portland, OR (US)

(21) Appl. No.: 17/003,624

(22) Filed: Aug. 26, 2020

(51) Int. Cl. F42B 27/00; F42B 12/48; A62C 4/00

(52) U.S. Cl. CPC F42B 27/00; A62C 4/00; F42B 12/48

(57) ABSTRACT

Flame arrestors for selectively securing to a smoke grenade having a smoke outlet. The flame arrestors include a base, a first screen, and a second screen. In some examples, the flame arrestor includes a thermal insulator. In some examples, the flame arrestor includes a special effects component.

### BACKGROUND

The present disclosure relates generally to flame arrestors. In particular, flame arrestors for smoke grenades are described.

Smoke grenades release copious amounts of smoke through exothermic reactions initiated with in a canister. Different smoke grenades will release smoke with different colors. Smoke grenades are used for a variety of purposes, including signaling; marking areas, such as target or landing zones; and for obscuring visibility, such as to screen movements of people and vehicles.

Smoke grenades are known to be a fire hazard because of the exothermic reactions they use to generate smoke. The outer surface of some smoke grenade canisters becomes very hot and can ignite vegetation or combustible materials by contact. Some smoke grenades release fire and sparks out of their canisters, which can ignite vegetation and combustible materials. Flames and sparks released from smoke grenades also cause injury to people and animals.

To reduce the risk of fire and injury from fire and sparks, some smoke grenades incorporate flame arrestors. However, known flame arrestors are not entirely satisfactory for the range of applications in which they are employed. Further, the limitations of existing flame arrestors results in most smoke grenades not including flame arrestors despite there being a need for them.

One limitation of existing flame arrestors is that they are not removable and reusable. In the limited instances where smoke grenades include a flame arrestor in some fashion, the flame arrestor is typically incorporated in a manner that does not allow the flame arrestor to be removed from the smoke grenade. Since the flame arrestor is riot removable, it can not be used on another smoke grenade offer the first smoke grenade is depleted.

A limitation of conventional smoke grenades is that they do not include means to enhance or customize the attributes of the smoke released from the smoke grenade. It would be desirable to selectively modify the color of the smoke to suit a given application. It would also be desirable to enhance the visual or auditory effects of the smoke being released, such as by incorporating glitter, flashes of light, or fireworks-like explosions.

Thus, there exists a need for flame arrestors that improve upon and advance the design of known flame arrestors. Examples of new and useful flame arrestors relevant to the needs existing in the field are discussed below.

### SUMMARY

The present disclosure is directed to flame arrestors for selectively securing to a smoke grenade having a smoke outlet. The flame arrestors include a first screen and a second screen. In some examples, the flame arrestor includes a thermal insulator. In some examples, the flame arrestor includes a special effects component.

### BRIEF DESCRIPTION OF THE DRAWINGS

FIG. 1 is a perspective view of a flame arrestor mounted on a smoke grenade.

FIG. 2 is an exploded view of the flame arrestor and he smoke grenade shown in FIG. 1 depicting a special effects packet between the first screen and the second screen.

FIG. 3 is a section view of the flame arrestor shown in FIG. 1 depicting the flame arrestor spaced from the smoke grenade and cleats extending from the flame arrestor towards the smoke grenade.

FIG. 4 is a top plait view of the flame arrestor showy in FIG. 1.

### DETAILED DESCRIPTION

The disclosed flame arrestors will become better understood through review of the following detailed description in conjunction with the figures. The detailed description and figures prov e merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated of individually described in the following detailed description.

Throughout the following detailed description, examples of various flame arrestors are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Flame Arrestors for Smoke Grenades

With reference to the figures, flame arrestors for smoke grenades will now be described. The flame arrestors discussed herein function to reduce or eliminate the risk of fires caused by smoke grenades. The flame arrestors described below limit or prevent sparks generated within the smoke grenade from being discharged beyond the smoke grenade to the external environment. Further, the flame arrestors described in this document function to protect the user of the smoke grenade from hot temperatures generated by the smoke grenade, which can be uncomfortable, painful, or harmful to the user.

The reader will appreciate from the figures and description below that the presently disclosed flame arrestors address many of the shortcomings of conventional flame arrestors. For example, the flame arrestors described herein make smoke grenades safer by limiting or preventing sparks generated by the smoke grenades from reaching the external environment. By limiting the release of sparks, the presently described flame arrestors reduce the risk that a smoke grenade will start a fire when operating to produce and release smoke.

Another improvement over conventional flame arrestors is that the flame arrestors described in this document are removable and reusable. By being configured for easy coupling and removal, the flame arrestors can easily be used on multiple smoke grenades. The reusable nature of the flame arrestors described herein makes them economical and environmentally responsible. The economical nature of the flame arrestors described herein will also serve to increase their adoption and use compared to the current reality where flame arrestors on smoke grenades are rare.

Unlike existing smoke grenades and flame arrestors, the flame arrestors described in this application accommodate features to enhance or customize the attributes of the smoke released from smoke grenades. The special effects features incorporated into the presently described flame arrestors allow a user to selectively modify the color of the smoke to suit a given application. The special effects features incorporated into the presently described flame arrestors also allow a user to enhance the visual and/or auditory effects of the smoke being released. For example, the special effects features may release glitter, generate flashes of light, and/or produce fireworks-like explosions.

Contextual Details

Ancillary features relevant to the flame arrestors described herein will first be described to provide context and to aid the discussion of the flame arrestors.

Smoke Grenade

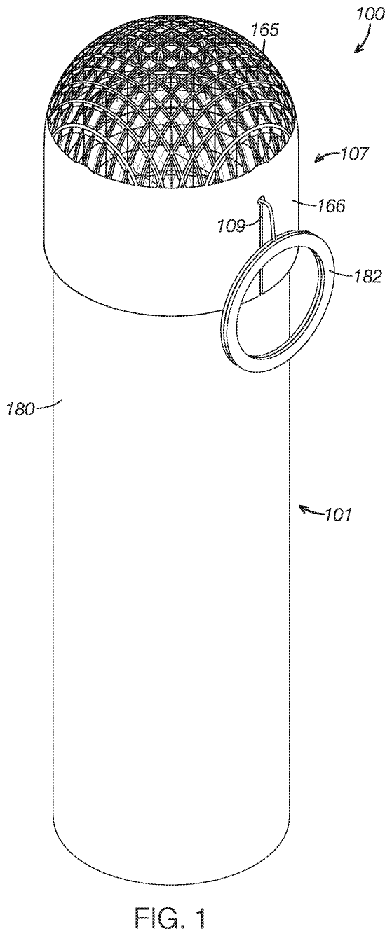

Smoke grenade 101 depicted in FIGS. 1-3 functions to produce and release smoke from a smoke outlet 102 via an exothermic reaction. As shown in FIGS. 1-3, smoke grenade 101 includes a cannister 180, a fuse 181, and a pullcord 182. The reader should understand that the particular smoke grenade depicted in FIGS. 1-3 is just one example of a suitable smoke grenade with which the flame arrestors described in this document may be used. Other smoke grenades will be configured differently, yet work equally well with the flame arrestors described herein.

Cannister 180 houses the chemicals used to produce smoke in a chamber 183. Cannister 180 defines a chamber outlet 184 providing fluid communication between fuse 181 and the chemicals contained in chamber 183. Fuse 181 is disposed proximate chamber outlet 184 to enable fuse 181 to ignite the chemicals within chamber 183 when lit by pulling pull cord 182. Once the chemicals are ignited by fuse 181, smoke is produced and exits smoke grenade 101 through smoke outlet 102.

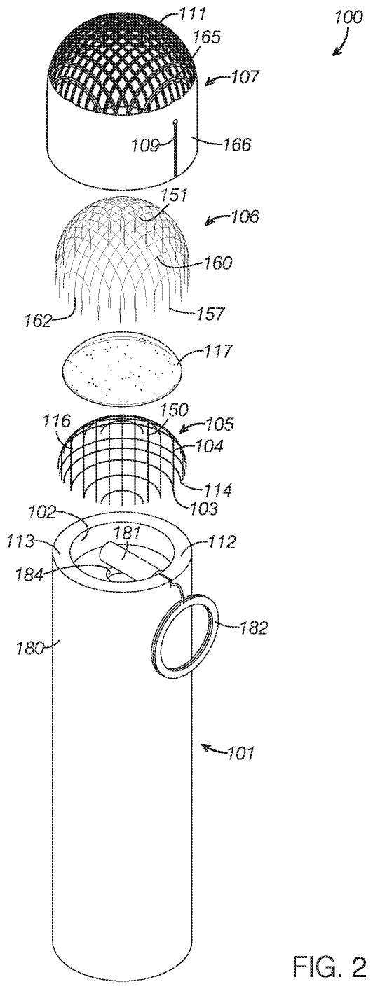

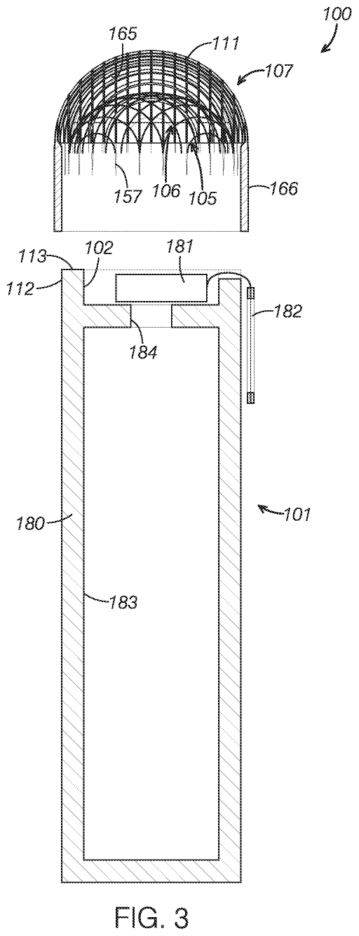

With reference to FIGS. 1-3, the reader can see that smoke grenade 101 includes a rim 112 extending around smoke outlet 102. As shown in FIGS. 2 and 3, smoke outlet 102 is circular in the present example. Rim 112 has a rim outer face 113, which is substantially flat in the example shown in FIGS. 1-3.

Flame Arrestor

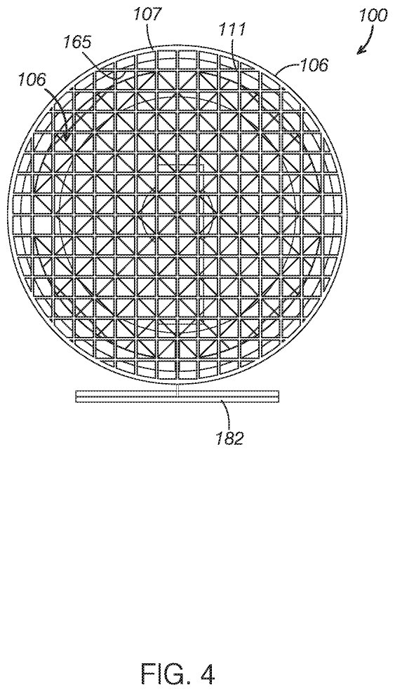

With reference to FIGS. 1-4, a flame arrestor 100 for selectively securing to a smoke grenade 101 having a smoke outlet 102 will now be described. The reader can see in FIGS. 1-4 that flame arrestor 100 includes a first screen 105, a second screen 106, a thermal insulator 107, and a special effects component 117. In some examples, the flame arrestor includes fewer components than depicted in FIGS. 1-4, such as not including a thermal insulator, a second screen, and/or a special effects component. In certain examples, the flame arrestor includes additional or alternative components.

First Screen

First screen 105 functions to block sparks generated by smoke grenade 101 from exiting smoke grenade 101. Further, first screen 105 serves to allow smoke produced by smoke grenade 101 to exit smoke grenade 101 substantially unimpeded.

In the example shown in FIGS. 1-4, first screen 105 includes first screen wires 104 and a base 103. First screen wires 104 define first mesh openings 150. In the example shown in FIGS. 1-4, base 103 is circular.

The reader can see in FIGS. 1-4 that first screen wires 104 form a domed shape. In some examples, the first screen has a shallower dome than depicted in FIGS. 1-4. In certain examples, the first screen fiat rather than domed. The reader should understand that the first screen may be any suitable shape that covers smoke outlet 102, such as flat, domed, spherical, pyramidal, cubical, and irregular shapes.

Base 103 defines a lip 114 complementarily configured with rim 112. Base 103 being complementarily configured with rim 112 enables lip 114 to rest on rim outer face 113. In examples where the rim of the smoke outlet circular, the base of the first screen may be a shape other than circular as well.

In the example shown in FIGS. 1-4, first screen 105 defines a more open mesh than second screen 106. First screen wires 104 of first screen 105 define a mesh size of 6 with 35 gauge wires. The mesh openings are approximately 3350 micrometers in size and the wire diameters are approximately 143 micrometers. The reader should appreciate the mesh size and wire gauge may be selected to suit a given application. Smaller and larger mesh size and wire gauge parameters are contemplated.

In the example depicted in FIGS. 1-4, first screen 105 is comprised of metal. In particular, first screen 105 is comprised of 304 stainless steel. However, the first screen may be comprised of any currently known or later developed material suitable for blocking sparks from exiting a smoke grenade. For example, the first screen may be comprised of metal, ceramics, polymers, and composite materials.

In the example shown in FIGS. 1-4, first screen 105 is coated with a flame-resistant coating 116. Any currently known or later developed flame resistant coating suitable for flame arrestor applications may be used. For example, the flame-resistant coating may be based chlorinated alkyds or brominated epoxy resin and filled aluminum hydroxide or a combination of chlorinated paraffin and an antimony oxide system. Different classes of flame resistant components, including halogen, phosphorus, nitrogen, mineral, oxide, intumescent, and nanofiller components may be incorporated into the flame resistant coating formulations to inhibit or retard the first screen from burning.

Second Screen

Like first screen 105, second screen 106 functions to block sparks generated by smoke grenade 101 from exiting smoke grenade 101. Second screen 106 provides an additional layer of protection against sparks passing through flame arrestor 100 beyond first screen 105. Further, second screen 106 allows smoke produced by smoke grenade 101 to pass through flame arrestor 100 substantially unimpeded.

In the example shown in FIGS. 1-4, second screen 106 includes second screen wires 160 and a base 162. Second screen wires 160 define second mesh openings 151. In the example shown in FIGS. 1-4, base 162 is circular.

As shown in FIGS. 1-4, second screen 106 complements the shape of first screen 105 and is disposed around first screen 105. Since first screen 105 is domed in the present example, second screen 106 is also domed. In some examples, the second screen has a shallower dome than depicted in FIGS. 1-4. In certain examples, the second screen is flat rather than domed. The reader should understand that the second screen may be any suitable shape that covers smoke outlet 102, such as flat, domed, spherical, pyramidal, cubical, and irregular shapes.

Base 162 of second screen 106 is complementarily configured with rim 112. Base 162 being complementarily configured with rim 112 enables base 162 to rest on rim outer face 113. In examples where the rim of the smoke outlet is not circular, the base of the second screen may be a shape other than circular as well.

As shown in FIGS. 2 and 3, second screen 106 includes cleats 157 extending towards rim outer face 113. Cleats 157 are configured to couple to smoke grenade 101 by penetrating rim outer face 113. In the example shown in FIGS. 1-4, cleats 157 are extensions of second screen wires 160. As shown in FIG. 3, cleats 157 extend beyond first screen 105 when second screen 106 overlies first screen 105. In some examples, the second screen does not include cleats.

In the example shown in FIGS. 1-4, second screen 106 defines a tighter mesh than first screen 105. Second screen wires 160 of second screen 106 define a mesh size of 8 with 28 gauge wires. The mesh openings are approximately 2360 micrometers in size and the wire diameters are approximately 321 micrometers. The reader should appreciate the mesh size and wire gauge may be selected to suit a given application. Smaller and larger mesh size and wire gauge parameters are contemplated.

In the example depicted in FIGS. 1-4, second screen 106 is comprised of metal. Specifically, second screen 106 is comprised of 304 stainless steel. However, the second screen may be comprised of any currently known or later developed material suitable for blocking sparks from exiting a smoke grenade. For example, the second screen may be comprised of metal, ceramics, polymers, and composite materials.

In the example shown in FIGS. 1-4, second screen 106 is coated with a flame-resistant coating. Any currently known or later developed flame resistant coating suitable for flame arrestor applications may be used. For example, the flame-resistant coating may be based on chlorinated alkyds or brominated epoxy resin and filled aluminum hydroxide or a combination of chlorinated paraffin and an antimony oxide system. Different classes of flame resistant components, including halogen, phosphorus, nitrogen, mineral, oxide, intumescent, and nanofiller components may be incorporated into the flame resistant coating formulations to inhibit or retard the second screen from burning.

Thermal Insulator

Thermal insulator 107 functions to limit the temperature of the outer surface of flame arrestor 100. Limiting the temperature of the outer surface of flame arrestor 100 reduces the risk that vegetation and combustible materials that come into contact with flame arrestor 100 will be ignited from the heat generated by exothermic reactions within smoke grenade 100 and absorbed by second screen 106. Limiting the temperature of the outer surface of flame arrestor 100 also reduces the risk that a person or animal contacting flame arrestor 100 will be burned or otherwise injured from the heat generated by exothermic reactions within smoke grenade 100 and absorbed by second screen 106.

As depicted in FIGS. 1-4, thermal insulator 107 is mounted to smoke grenade 101 proximate smoke outlet 102 and to the outside of second screen 106. With reference to FIGS. 1-3, the reader can see that thermal insulator 107 is configured to couple to smoke grenade 101 via a friction fit around the outside of cannister 180. Thermal insulator 107 extends along cannister 180 beyond smoke outlet 102 to define a sleeve portion 166. The length of the sleeve portion of the thermal insulator may be longer or shorter than depicted in FIGS. 1-3.

As shown in FIGS. 1-3, thermal insulator 107 defines a notch 109 configured to accommodate a projection extending from smoke grenade 101. In the example shown in FIGS. 1-4, the projection is pullcord 182 used to light fuse 181 to initiate the exothermic, smoke producing reactions in smoke grenade 101.

The reader can see in FIGS. 1-4 that thermal insulator 107 abuts second screen 106 and is complementarily configured with the size and shape of second screen 106. As depicted in FIGS. 1-4, thermal insulator 107 defines a third screen 111 with third mesh openings 165. Third mesh openings 165 of thermal insulator 107 allow smoke to exit flame arrestor and may be any suitable mesh configuration and size.

In the present example, thermal insulator 107 is formed from silicon. In other examples, other thermally insulating materials are used, such as diatomaceous earth. The thermal insulator may be formed from any currently known or later developed thermal insulating material that can be formed into a domed mesh screen.

Special Effects Component

Special effects component 117 is configured to interact with smoke released from smoke grenade 101 to alter the visual appearance of the smoke. Special effects component is configured to activate in response to the heat produced by smoke grenade 101 producing smoke via exothermic reactions.

In the present example, as shown most clearly in FIG. 3, special effects component 117 is disposed between first screen 105 and second screen 106. In other examples, the special effects component is disposed between the second screen and the thermal insulator. In certain examples, the special effects component is placed within the domed area of the first screen between the first screen and the smoke outlet.

The special effects component may customize the attributes of the smoke released from the smoke grenade in a variety of ways. For example, the special effects component may be configured to modify the color of the smoke to suit a given application, such as green smoke to communicate it is safe to approach or red smoke to communicate that one should stop. The special effects component may enhance the visual and/or auditory effects of the smoke being released by releasing glitter, generating flashes of light, and/or producing fireworks-like explosions.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of he disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A flame arrestor for selectively securing to a smoke grenade having a smoke outlet, the flame arrestor comprising:
a first screen complementarily configured with the smoke outlet and selectively mounted on the smoke outlet, the first screen covering the smoke outlet and defining first mesh openings; and
a second screen complementarily configured with the smoke outlet and overlaying the first screen, the second screen defining second mesh openings.

2. The flame arrestor of claim 1, further comprising a thermal insulator covering the second screen.

3. The flame arrestor of claim 2, wherein the thermal insulator is mounted to the smoke grenade proximate the smoke outlet.

4. The flame arrestor of claim 3, wherein the thermal insulator is configured to couple to the smoke grenade via a friction fit.

5. The flame arrestor of claim 4, wherein the thermal insulator defines a notch configured to accommodate a projection extending from the smoke grenade.

6. The flame arrestor of claim 2, wherein the thermal insulator abuts the second screen.

7. The flame arrestor of claim 2, wherein the thermal insulator defines a third screen with third mesh openings.

8. The flame arrestor of claim 1, wherein:
the smoke grenade includes a rim extending around the smoke outlet, the rim having a rim outer face that is substantially flat; and
the base defines a lip complementarily configured with the rim to facilitate the lip resting on the rim outer face.

9. The flame arrestor of claim 8, wherein the second screen includes cleats extending towards the rim around the smoke outlet, the cleats being configured to couple to the smoke grenade by penetrating the rim outer face.

10. The flame arrestor of claim 9, wherein the cleats extend beyond the first screen when the second screen overlies the first screen.

11. The flame arrestor of claim 10, wherein:
the second screen includes second screen wires defining the second mesh openings; and
the cleats are extensions of the second screen wires.

12. The flame arrestor of claim 1, wherein the first screen is domed.

13. The flame arrestor of claim 12, wherein the second screen is domed.

14. The flame arrestor of claim 1, wherein the first mesh openings are larger than the second mesh openings.

15. The flame arrestor of claim 1, wherein the first screen is comprised of metal.

16. The flame arrestor of claim 15, wherein the second screen is comprised of metal.

17. The flame arrestor of claim 16, wherein the first screen is coated with a flame-resistant coating.

18. The flame arrestor of claim 17, wherein the second screen is coated with a flame-resistant coating.

19. The flame arrestor of claim 1, further comprising a special effects component disposed between the first screen and the second screen, the special effects component being configured to interact with smoke released from the smoke grenade to alter the visual appearance of the smoke.

20. The flame arrestor of claim 1, wherein:
the smoke outlet is circular; and
the first screen includes a circular base.
